(19) United States
(12) Patent Application Publication
(10) Pub. No.: US 2021/0293320 A1
(43) Pub. Date: Sep. 23, 2021

(54) TRANSMISSION HOUSING ASSEMBLY WITH A FREEWHEEL FOR SUPPORTING A MOTOR SHAFT

(71) Applicant: Nidec Corporation, Kyoto (JP)

(72) Inventors: Pascual GUARDIOLA, Ingersheim (DE); Uwe LASEBNICK, Stuttgart (DE)

(21) Appl. No.: 17/156,776

(22) Filed: Jan. 25, 2021

(30) Foreign Application Priority Data
Mar. 19, 2020 (DE) 102020107596.0

(51) Int. Cl. F16H 57/021; F16D 41/00; B60K 1/00; F16H 57/023; B23P 19/04

(52) U.S. Cl. CPC F16H 57/021; F16D 41/00; F16H 2057/02034; F16H 57/023; B23P 19/04; B60K 1/00

(57) ABSTRACT

A transmission housing assembly includes a transmission housing and a freewheel including an inner ring and an outer ring. The inner ring is non-positively connectable to a motor shaft. The transmission housing includes a steel bearing bush overmolded with aluminum, which defines an opening of the transmission housing into which the freewheel is pressed.

### CROSS REFERENCE TO RELATED APPLICATION

The present invention claims priority under 35 U.S.C. § 119 to German Application No. 102020107596.0 filed on Mar. 19, 2020, the entire contents of which are hereby incorporated herein by reference.

### 1. FIELD OF THE INVENTION

The present disclosure relates to a transmission housing assembly with a freewheel that supports an engine shaft, and in particular to an automatic transmission of a motor vehicle, as well as to an actuator of a motor vehicle automatic transmission and a method for producing a transmission housing assembly of an actuator of a motor vehicle automatic transmission.

### 2. BACKGROUND

It is known to mount motor shafts in a freewheel to protect the motor from damage. If the motor is followed by a transmission, the freewheel can be mounted in the transmission housing, especially in the housing. In this case, the freewheel is pressed into the housing. However, this press fit does not provide a reliable fit over a wide temperature range.

### SUMMARY

Example embodiments of the present disclosure provide gear housing assemblies each including a freewheel to support a motor shaft, which provides a safe and cost-effective connection between gear housing and freewheel.

A transmission housing assembly according to an example embodiment of the present disclosure includes a transmission housing and a freewheel including an inner ring and an outer ring. The inner ring is non-positively connectable to a motor shaft. The transmission housing includes a steel bearing bush injection-overmolded with aluminum, which defines an opening in the transmission housing into which the freewheel is pressed.

The use of a steel bearing bushing ensures that the freewheel is firmly seated in the transmission housing over a wide temperature range and that the forces generated by reverse rotation of the motor shaft can be absorbed. Because the steel bearing bushing is overmolded during production of the transmission housing, the transmission housing does not have to be additionally machined to accommodate the freewheel. The freewheel is preferably a ball bearing freewheel.

Preferably, the opening of the gear housing is located centrally in the gear housing.

The steel bearing bushing preferably has a non-round shape on the outside.

Preferably, the transmission housing assembly includes the motor shaft and the inner ring of the freewheel is seated on the motor shaft and pressed onto it.

It is preferably provided that the freewheel includes a backstop and allows torque transmission in one direction only, the forward direction of rotation of the electric motor.

Furthermore, an actuator of a vehicle automatic transmission includes an electric motor with a motor shaft and a transmission with a previously described transmission housing assembly.

In addition, a method of producing a transmission housing assembly of an actuator of a motor vehicle automatic transmission according to an example embodiment of the present disclosure includes providing a mold to form a gear housing of the gear housing assembly, inserting a steel bearing bushing into the mold, pressing aluminum into the mold and forming a positive connection between the aluminum and the steel bearing bushing and a transmission housing with an opening defined by the steel bearing bushing, and pressing a freewheel into the steel bearing bushing.

The use of a steel bearing bushing ensures that the freewheel is firmly seated in the transmission housing over a wide temperature range. Because the steel bearing bushing is overmolded during the production of the transmission housing, the transmission housing does not have to be additionally machined to accommodate the freewheel.

The steel bearing bushing on the outside preferably has a non-round shape.

The freewheel preferably includes an inner ring and an outer ring.

A gear housing assembly of an example embodiment of the present disclosure includes a motor shaft with the inner ring of the freewheel being press-fit on the motor shaft.

The freewheel preferably includes a backstop and allows rotation of the motor shaft only in one direction, the forward rotation direction of the motor.

The freewheel is preferably a ball bearing freewheel.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Identical or functionally identical components are provided with the same reference signs in the figures.

FIG. 1 is an exploded view of a transmission housing according to an example embodiment of the present disclosure with freewheel.

FIG. 2 is an isometric representation of the assembled gear housing according to an example embodiment of the present disclosure.

### DETAILED DESCRIPTION

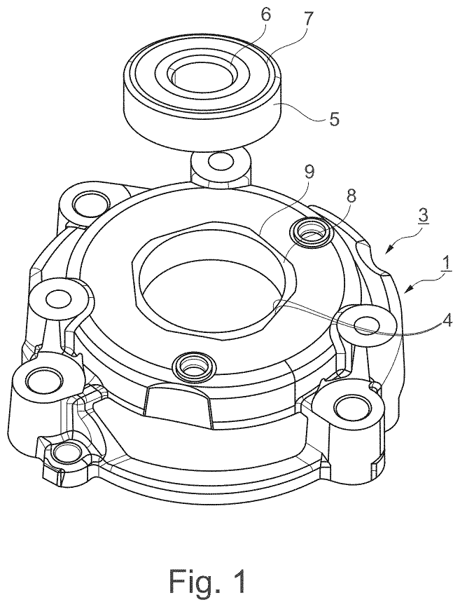

FIG. 1 shows a gear housing 1 of a gear housing assembly 3. The gear housing 1 has a central opening 4 into which a freewheel 5 is inserted. The freewheel 5 is a ball bearing freewheel with inner ring 6 and outer ring 7. The ball bearing freewheel 5 is used as a backstop, i.e. it prevents the motor shaft not shown from rotating backwards.

The outer ring 7 has not shown recesses on the inside, in which balls are accommodated. The balls are spring preloaded towards a clamping position. The recesses extend in the circumferential direction, with the depth of the recess decreasing continuously in the opposite direction to the direction of forward rotation of the motor. In the clamping position, the depth is so small that the balls are clamped between the inner ring 6 and the outer ring 7 so that rotation of the motor shaft in the reverse direction is prevented. If the inner ring 6 rotates with the motor shaft in the forward direction of rotation of the motor, the balls are pressed against the spring force into an area of the recess where the balls have no contact with both rings 6,7. In this freewheel area, the motor shaft can rotate freely without blocking.

The described ball bearing freewheel 5 is only one of many suitable freewheels with backstop available on the market. Also available are freewheels without springs, with cylindrical rollers instead of balls and/or freewheels with sprags. Depending on the application, an appropriate freewheel must be selected.

Transmission housing 1 is made of aluminum and is manufactured by die-casting aluminum. However, due to the high coefficient of thermal expansion, the aluminum housing is not suitable for a secure and tight fit of the freewheel 5 in the opening 4 and for good support of the occurring forces at high temperatures.

Therefore, during the production of the transmission housing 1 using the aluminum die casting process, a steel bearing bush 8 is placed in the casting mold. The molten metal is pressed under high pressure into the preheated casting mold and injected around the steel bearing bushing 8.

To ensure that the steel bearing bushing 8 is firmly seated in the gear unit housing 1, the steel bearing bushing 8 has a non-circular shape on the outside 9.

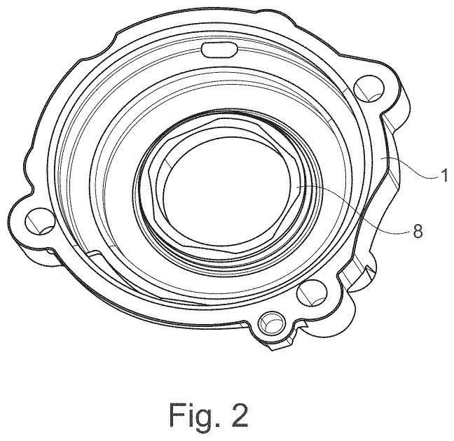

FIG. 2 shows the gear housing 1 as seen from below on the steel bearing bushing 8. The die casting process creates an inseparable positive connection between the aluminum and the steel bearing bushing 8. The freewheel 5 is pressed into the steel bearing bushing 8 during assembly. The steel bearing bushing 8 holds the freewheel 5 securely in position over a temperature range of −40° C. to 150° C. with constant force absorption.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A transmission housing assembly, comprising:
a transmission housing; and
a freewheel including an inner ring and an outer ring; wherein
the inner ring is non-positively connectable to a motor shaft;
the transmission housing includes a steel bearing bush overmolded with aluminum which defines an opening in the transmission housing;
the freewheel is pressed into the opening in the transmission housing.

2. The transmission housing assembly according to claim 1, wherein the opening of the transmission housing is centrally located in the transmission housing.

3. The transmission housing assembly according to claim 1, wherein the steel bearing bushing has a non-round shape on its outside.

4. The transmission housing assembly according to claim 1, wherein the inner ring of the freewheel is seated on a motor shaft and pressed thereto.

5. The transmission housing assembly according to claim 1, wherein the freewheel includes a backstop and allows rotation of the motor shaft in only one direction.

6. An actuator of an automotive automatic transmission, the actuator comprising:
an electric motor with a motor shaft; and
a transmission with the transmission housing assembly according to claim 1.

7. A method for producing a transmission housing assembly of an actuator of a motor vehicle automatic transmission, the method comprising:
providing a casting mold to form a transmission housing of the transmission housing assembly;
inserting a steel bearing bushing into the mold;
pressing aluminum into the mold and forming a positive connection between the aluminum and the steel bearing bushing and an opening in the gear housing defined by the steel bearing bushing; and
pressing a freewheel into the steel bearing bushing.

8. The method according to claim 7, wherein the steel bearing bushing has a non-round shape on an outside.

9. The method according to claim 7, wherein the freewheel includes an inner ring and an outer ring.

10. The method according to claim 9, wherein
the transmission housing assembly includes a motor shaft; and
the method further includes pressing the inner ring of the freewheel with the motor shaft.

11. The method according to claim 7, wherein the freewheel includes a backstop and allows a rotational movement of the motor shaft in only one direction.

12. The method according to claim 7, wherein the freewheel is a ball bearing freewheel.
